(19) United States
(12) Patent Application Publication
(10) Pub. No.: US 2018/0198234 A1
(43) Pub. Date: Jul. 12, 2018

(54) Movable Connector

(71) Applicant: IRISO ELECTRONICS CO., LTD., Kanagawa (JP)

(72) Inventor: Toru Takane, Kanagawa (JP)

(73) Assignee: IRISO ELECTRONICS CO., LTD., Kanagawa (JP)

(21) Appl. No.: 15/854,915

(22) Filed: Dec. 27, 2017

(30) Foreign Application Priority Data
Jan. 11, 2017 (JP) 2017-002959

(51) Int. Cl. H01R 13/631; H01R 13/405; H01R 13/24

(52) U.S. Cl. CPC H01R 13/6315; H01R 13/2407; H01R 13/405

(57) ABSTRACT

To reduce the displacement load of a spring portion in order to improve the workability of insertion and extraction of a movable connector. A spring portion has an upper piece portion and a lower piece portion having a linear shape, and is formed in such a square wave shape that an outer vertical piece portion having a linear portion extends from a first end of the upper piece portion, a central vertical piece portion having a linear shape and connected to a first end of the lower piece portion extends from a second end of the upper piece portion, and an inner vertical piece portion having a linear shape extends from a second end of the lower piece portion.

### BACKGROUND OF THE INVENTION

### 1. Field of the Invention

The present invention relates to a movable connector having a floating function.

### 2. Description of the Related Art

The movable connector is known as an electric connector including a fixed housing fixed to a board, a movable housing fitted and connected to a connection object, and a terminal connecting the fixed housing and the movable housing. The terminal of the movable connector includes a first fixing portion that is fixed to the fixed housing (the first housing), a second fixing portion that is fixed to the movable housing (the second housing), and a spring portion that connects the first fixing portion and the second fixing portion and supports the movable housing displaceably relative to the fixed housing.

The spring portion is formed into a shape having a bent portion curved in an arc shape as shown, for example, in Japanese Patent No. 5849166 (paragraphs 0084 to 0088), and has a function of absorbing displacement of the movable housing moving relative to the fixed housing by elastic deformation of the entire spring portion. Such a function of absorbing displacement of the movable housing by the spring portion can be exerted, for example, at the time of fitting connection in which the movable housing is displaced when inserting a connection object (for example, a connector or a board to be conductively connected) into the movable housing, and when the movable housing is displaced due to vibration or shock under the usage environment after fitting connection with the connection object.

Meanwhile, the movable connector disclosed in Japanese Patent No. 5849166 (paragraph 0084 to 0088) is a Z direction movable connector proposed by the present applicant. The Z direction movable connector is a connector having such a function that in a state where the contact portion of the terminal holds the contact position with the connection object, the spring portion elastically deforms in a direction in which the connection object is inserted into and extracted from the movable connector (Z direction). One characteristic thereof is that even if the spring portion is elastically deformed in the Z direction, the contact portion of the terminal holds the contact position with the connection object. Therefore, since the contact portion does not slide slightly relative to the connection object, abrasion hardly occurs, and there is an advantage that the reliability of the conductive connection hardly deteriorates. However, in order for the contact portion to hold the contact position with the connection object, it is necessary to set the contact pressure of the contact portion with respect to the connection object to be high so that even if the spring portion is elastically deformed in the Z direction, the contact portion does not slide slightly. However, if the contact pressure is set high, insertion and extraction of the connection object into and from the movable connector becomes hard and the workability is lowered.

First of all, in order to improve the workability, it is conceivable to reduce the force required for inserting and extracting the connection object by reducing the contact pressure of the contact portion. However, when the contact pressure is lowered, the holding force for maintaining the contact position with the connection object is decreased, and the risk of the slight sliding is increased. Improvement in workability of insertion and extraction cannot be achieved merely by lowering the contact pressure.

The present invention has been made on the background of the above conventional art. An object of the present invention is to improve workability of insertion and extraction of the movable connector.

### SUMMARY OF THE INVENTION

To attain the above object, the present invention is configured to have the following characteristics.

According to the present invention, a movable connector includes a first housing, a second housing that is fitted and connected to a connection object, and a terminal including a first fixing portion fixed to the first housing, a second fixing portion fixed to the second housing, a spring portion connecting the first fixing portion and the second fixing portion and supporting the second housing displaceably relative to the first housing, and a contact portion that makes conductive contact with the connection object. The spring portion has an upper piece portion and a lower piece portion having a linear shape and extending in a direction intersecting with a fitting direction in which the connection object is fitted and connected to the second housing, a first extending portion connecting a first end of the upper piece portion and the first fixing portion, and a second extending portion connecting a second end of the upper piece portion and a first end of the lower piece portion.

As described above, improving the workability of insertion and extraction cannot be achieved merely by lowering the contact pressure of the contact portion. Therefore, the present inventor paid attention to lowering the contact pressure of the contact portion and simultaneously reducing the displacement load of the spring portion. As a result of studies, it was found that, in a terminal having a spring portion having a bent portion curved in an arc shape as shown in the conventional art, when receiving a load of fit connection with a connection object, the stress tends to be dispersed particularly in the longitudinal direction and the plate thickness direction of the arc-shaped bent portion, and therefore a large load is required for the spring portion to obtain a predetermined amount of displacement. In other words, the conventional spring portion has a shape that makes it difficult to reduce the displacement load.

In contrast, the spring portion of the present invention has not a bent portion curved in an arc shape but an upper piece portion and a lower piece portion having a linear shape, and is formed in such a shape that a first extending portion extends from a first end of the upper piece portion, and a second extending portion extends from a second end of the upper piece portion. In the square wave-shaped spring portion in which linear spring pieces are connected by corner portions, stress is not equally distributed in the longitudinal direction and plate thickness direction of the arc-shaped bent portion as in the spring portion of the conventional art. That is, since the upper piece portion, the lower piece portion, the first extending portion, and the second extending portion function as spring pieces connected by corner portions, it is easy to reduce the displacement load of the spring portion. Therefore, in the movable connector of the present invention, since the displacement load of the spring portion can be reduced, not only the contact pressure of the contact portion but also the displacement load of the spring portion can be reduced, thereby improving the workability of insertion and extraction. Therefore, if this is applied to the above-mentioned Z direction movable connector, it is possible to realize a Z direction movable connector having high reliability of conductive connection and good workability of insertion and extraction. Further, the movable connector of the present invention can also be configured as a movable connector that is not a Z direction movable connector, and a movable connector in which the displacement load of the spring portion is small and the second housing is displaced by flexible elastic deformation can be realized.

In order to configure the movable connector of the present invention as the Z direction movable connector, it is preferable that the displacement load at which the spring portion is displaced is smaller than the load at which the contact portion is displaced from the contact position at which the contact portion is in press contact with the connection object. According to this, since even if the spring portion is displaced, the contact portion holds the contact position with the connection object, the contact portion does not slide slightly relative to the connection object, so that abrasion hardly occurs, and it is possible to realize a Z direction movable connector having high reliability of conductive connection.

The second extending portion may have such a shape that it extends obliquely so as to be gradually separated from the first extending portion from the second end of the upper piece portion toward the first end of the lower piece portion. According to this, it is possible to prevent the second extending portion from coming into contact with the first extending portion when the upper piece portion and the lower piece portion are displaced towards each other.

The upper piece portion may be formed to be longer than the lower piece portion. The second housing can be grasped as a movable housing displaceable relative to the first housing, and the first housing can be grasped as a fixed housing. Here, among the upper piece portion and the lower piece portion, the closer portion to the first housing which is the fixed housing is the upper piece portion. If the upper piece portion is formed to be longer than the lower piece portion, the displacement load of the spring portion can be further reduced.

According to the movable connector of the present invention, it is possible to reduce the displacement load of the spring portion. Therefore, when this is applied to, for example, a Z direction movable connector, the contact pressure of the contact portion is reduced and the displacement load of the spring portion can be reduced. Therefore, even if the spring portion is displaced in the Z direction, the contact portion does not slide slightly, so that abrasion hardly occurs, and workability of insertion and extraction of the connection object can be improved while achieving high reliability of conductive connection. With respect to the movable connector that is not the Z direction movable connector, the displacement load of the spring portion can be reduced. In other words, it is possible to increase the amount of displacement (movable amount) when the displacement load is fixed.

### BRIEF DESCRIPTION OF THE DRAWINGS

FIG. 1 is a perspective view including the front, right side, and top of a movable connector according to an embodiment.

FIG. 2 is a front view of the movable connector of FIG. 1.

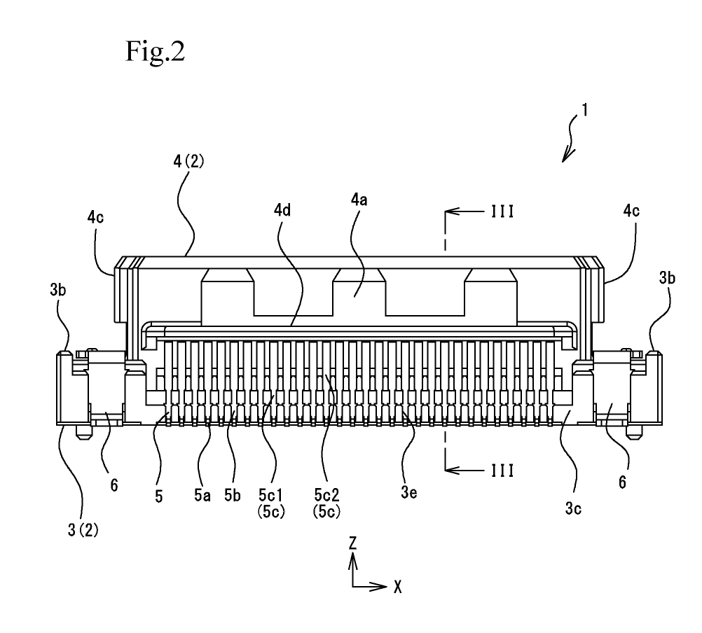

FIG. 3 is an enlarged sectional view taken along line III-III of FIG. 2.

FIG. 4 is an exterior perspective view of a terminal provided in the movable connector of FIG. 1.

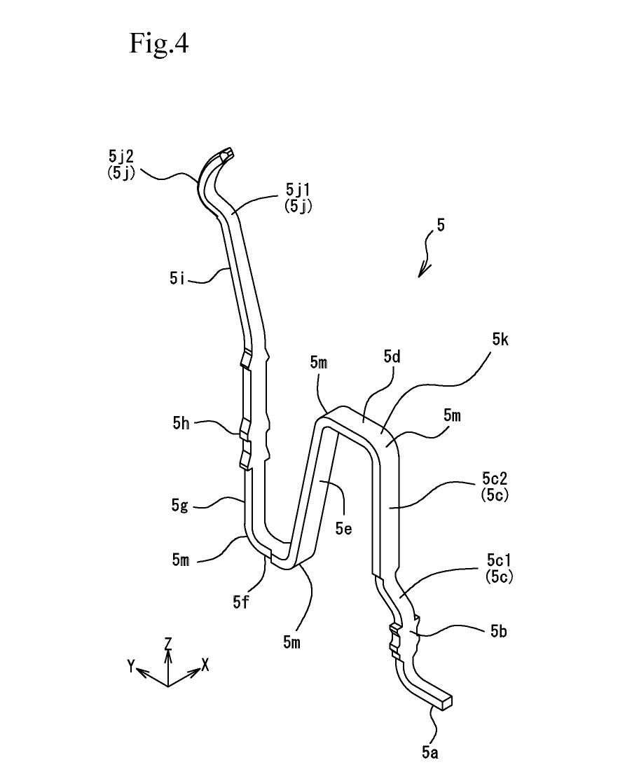

FIGS. 5A and 5B are explanatory views showing modifications of the spring portion of the terminal.

FIGS. 6A to 6D are explanatory views schematically showing the stress distributions of the spring portions according to the embodiment and comparative examples.

### DESCRIPTION OF THE PREFERRED EMBODIMENTS

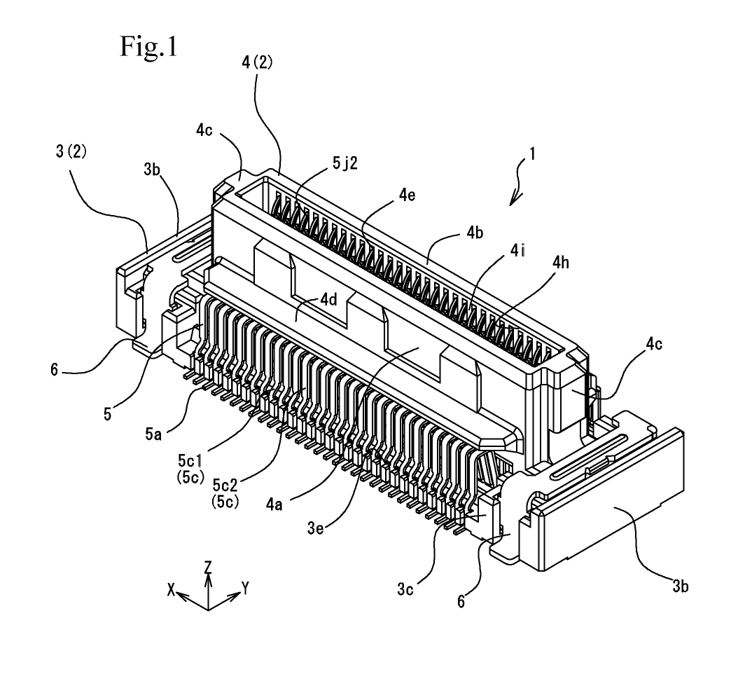

Hereinafter, an embodiment of the present invention will be described with reference to the drawings. In the present specification, claims, and drawings, the arrangement direction (the left-right direction) of the terminals of the movable connector shown in FIG. 1 is the X direction, the depth direction (the front-rear direction) of the movable connector is the Y direction, and the height direction (the up-down direction) is the Z direction. However, such specifying of left-right, front-rear, and up-down does not limit the mounting direction and use direction of the movable connector of the present invention.

### Configuration of Movable Connector 1

The movable connector 1 includes a housing 2 molded of a hard resin. The housing 2 is composed of a fixed housing 3 as a “first housing” and a movable housing 4 as a “second housing.” Terminals 5 are metal pieces and are each fixed to the fixed housing 3 and the movable housing 4.

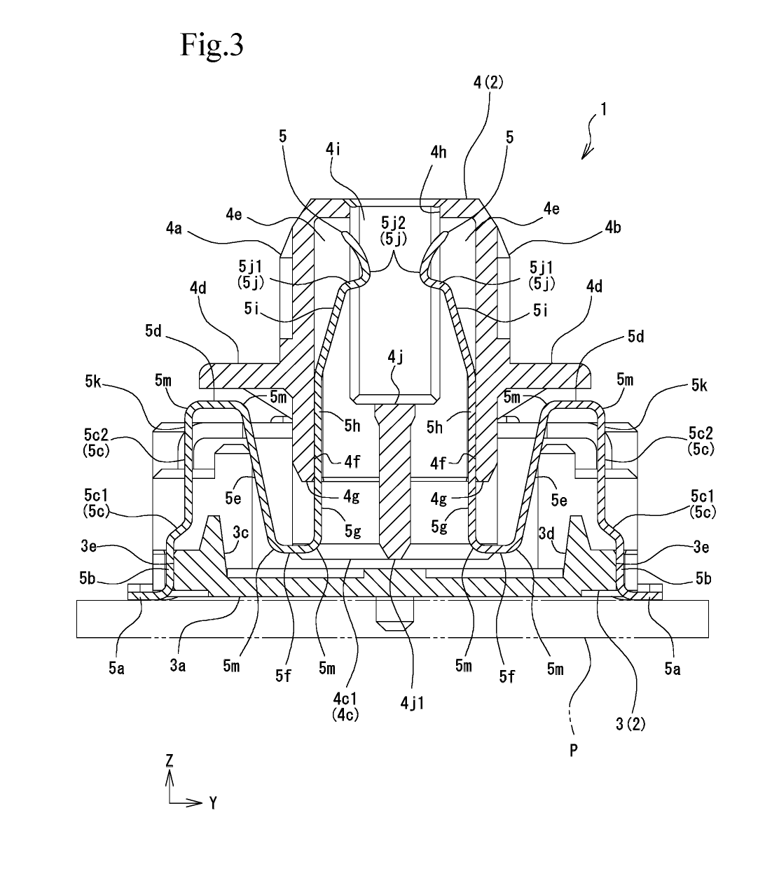

The fixed housing 3 is mounted on a board P. The fixed housing 3 is formed in a rectangular shape whose longitudinal direction is along the X direction. The fixed housing 3 has a bottom wall portion 3a formed in rectangle and single plate-shaped (FIG. 3), so that the movable housing 4 and the terminals 5 disposed on the fixed housing 3 are not exposed to the board P. This prevents the board P from being bowed by being pressed by the movable housing 4 and thereby damaging the elements, the circuit wiring, and the soldered portions, so that the surface just under the bottom wall portion 3a can be used for circuit wiring. Side wall portions 3b are formed at both ends of the bottom wall portion 3a, and fixing metal fittings 6 to be soldered to the board P are fixed to the side wall portions 3b. On the bottom wall portion 3a, a front wall portion 3c and a rear wall portion 3d are formed along the longitudinal edge of the bottom wall portion 3a. On the front wall portion 3c and the rear wall portion 3d, there are formed terminal fixing portions 3e that hold and fix the fixed housing fixing portion 5b of each of the arranged terminals 5 in the plate width direction (X direction).

As with the fixed housing 3, the movable housing 4 is formed in a rectangular tube shape whose longitudinal direction is along the X direction, and includes a front wall portion 4a, a rear wall portion 4b, and left and right wall portions 4c.

Eave-shaped protrusions 4d are formed on the outer surfaces of the front wall portion 4a and the rear wall portion 4b, and protect the terminals 5 thereunder from damage due to contact or the like. Slit-like terminal accommodating chambers 4e are formed in the inner surfaces of the front wall portion 4a and the rear wall portion 4b. The terminals 5 arranged along the X direction are each accommodated in a separate one of the terminal receiving chambers 4e. Terminal fixing portions 4f for fixing the terminals 5 are formed in the terminal accommodating chambers 4e, and fix the movable housing fixing portions 5h of the terminals 5 to the movable housing 4 by holding them in the plate width direction (X direction). Under the lower edges of the front wall portion 4a and the rear wall portion 4b, there are formed passing portions 4g for passing the lower piece portions 5f of the terminals 5 therethrough from the inside to the outside of the terminal accommodating chambers 4e of the movable housing 4 (FIG. 3). Since having the passing portions 4g, the front wall portion 4a and the rear wall portion 4b are formed shorter than the left and right side wall portions 4c on the lower side in the Z direction.

A fitting opening 4h for inserting a connection object is formed in the top surface of the movable housing 4, and a fitting chamber 4i is formed inside the opening. Under the fitting chamber 4i, a central partition wall 4j is formed at the center position in the Y direction along the X direction (FIG. 3). The connection object comes into contact with the central partition wall 4j so that excessive insertion of the connection object into the fitting chamber 4i can be stopped.

As shown in FIG. 3, the bottom surface portions 4c1 of the left and right side wall portions 4c of the movable housing 4 and the bottom surface portion 4j1 of the central partition wall 4j serve as stoppers that stop the displacement of the movable housing 4 by the movable housing 4 coming into contact with the bottom wall portion 3a of the fixed housing 3, the movable housing being displaced downward in the Z direction.

The terminals 5 are arranged along the X direction in parallel with the movable connector 1, and are disposed in two rows opposite in the Y direction. The terminals 5 have the same shape. Specifically, each of the terminals 5 has a board connecting portion 5a, a fixed housing fixing portion 5b as a “first fixing portion”, an outer vertical piece portion 5c as a “first extending portion”, an upper piece portion 5d, a central vertical piece portion 5e as a “second extending portion”, a lower piece portion 5f, an inner vertical piece portion 5g, a movable housing fixing portion 5h as a “second fixing portion”, an elastic arm 5i, and a contact portion 5j. Of these, the outer vertical piece portion 5c, the upper piece portion 5d, the central vertical piece portion 5e, the lower piece portion 5f, and the inner vertical piece portion 5g form a square wave-shaped spring portion 5k.

The board connecting portion 5a is a portion soldered to a circuit contact (not shown) of the board P and conductively connected to the board circuit.

The fixed housing fixing portion 5b and the movable housing fixing portion 5h are formed as fixing protrusions protruding in the plate width direction of the terminal 5. The fixed housing fixing portion 5b is press-fitted into and held by the terminal fixing portion 3e of the fixed housing 3 to fix a first end of the terminal 5 to the fixed housing 3. The movable housing fixing portion 5h is press-fitted into and held by the terminal fixing portion 4f of the movable housing 4 to fix a second end of the terminal 5 to the movable housing 4.

The outer vertical piece portion 5c is a portion that is in the square wave-shaped spring portion 5k and is exposed to the outside of the movable connector 1. A bent portion 5c1 is formed in the outer vertical piece portion 5c, and a linear portion 5c2 having a linear shape extending upward in the Z direction is formed over the bent portion 5c1.

The upper piece portion 5d and the lower piece portion 5f are formed in a linear shape extending in a direction (Y direction) intersecting with the fitting direction (Z direction) of the connection object inserted into the fitting chamber 4i of the movable housing 4. The upper piece portion 5d is located on the upper side of the square wave-shaped spring portion 5k, and the lower piece portion 5f is located on the lower side.

The central vertical piece portion 5e is a portion connecting the upper piece portion 5d and the lower piece portion 5f in the square wave-shaped spring portion 5k. The central vertical piece portion 5e is formed so as to extend obliquely so as to be gradually separated from the outer vertical piece portion 5c from the upper end toward the lower end. By thus forming it obliquely, it is possible to set a large gap between the lower end of the central vertical piece portion 5e and the front wall portion 3c and the rear wall portion 3d of the fixed housing 3, so that it is possible to secure a large amount of displacement of the lower piece portion 5f and the movable housing 4 in the Y direction. In the case where the fixed housing 3 does not have the front wall portion 3c and the rear wall portion 3d as in this embodiment, the gap between the lower end of the central vertical piece portion 5e and the outer vertical piece portion 5c can be set large, and it is possible to prevent them from being brought into contact due to displacement.

The inner vertical piece portion 5g is a portion that is in the square wave-shaped spring portion 5k and is located on the lower side of the movable housing 4. A first end of the inner vertical piece portion 5g is connected to the lower piece portion 5f, and a second end of the inner vertical piece portion 5g is connected to the movable housing fixing portion 5h. That is, the inner vertical piece portion 5g is formed in a linear shape extending in the fitting direction (Z direction) of the connection object inserted into the fitting chamber 4i of the movable housing 4, and has a function of supporting the movable housing 4 from below. Therefore, at the time of fitting connection of the connection object to the movable housing 4, the inner vertical piece portion 5g serves as a portion that receives the insertion force of the connection object along the Z direction.

The elastic arm 5i is formed obliquely so as to approach the fitting chamber 4i from the proximal end connected to the movable housing fixing portion 5h toward the distal end side connected to the contact portion 5j. The elastic arm 5i is a portion that elastically supports the contact portion 5j displaceably.

The contact portion 5j is a portion that makes conductive contact with the connection object. A bent portion 5j1 connected to the elastic arm 5i and bending toward the fitting chamber 4i is formed in the contact portion 5j. At the distal end of the bent portion 5j1, a contact 5j2 that is greatly curved in a mountain shape is formed. The distal end of the contact 5j2 is located in the terminal accommodating chamber 4e of the movable housing 4 so that the connection object is not caught on the distal end and the contact portion 5j and the elastic arm 5i do not buckle.

### Operation and Effect of Movable Connector 1

Next, the operation and effect of the movable connector 1 will be described.

The movable connector 1 of this embodiment is configured as a so-called Z direction movable connector. That is, in the state where the movable connector 1 is fitted and connected to the connection object, the displacement load at which the spring portion 5k is displaced is smaller than the load at which the contact portion 5j is slid and displaced from the contact position at which the contact portion 5j is in press contact with the connection object. Therefore, even if the spring portion 5k is displaced, the contact portion 5j holds the contact position with the connection object by the contact pressure. Therefore, since the contact 5j2 does not slide slightly relative to the connection object, abrasion such as plating peeling hardly occurs, and the movable connector 1 can exert high reliability of conductive connection while the movable housing 4 is displaceable.

However, although the contact pressure by the contact portion 5j exerts a holding force that prevents displacement relative to the connection object, it is set smaller than in the movable connector shown in the conventional art (Japanese Patent No. 5849166 (paragraphs 0084 to 0088)), and the displacement load of the spring portion 5k is also set smaller.

The spring portion 5k has, instead of a bent portion curved in an arc shape, an upper piece portion 5d and a lower piece portion 5f having a linear shape, and is formed in such a square wave shape that an outer vertical piece portion 5c having a linear portion 5c2 extends from a first end of the upper piece portion 5d, a central vertical piece portion 5e having a linear shape and connected to a first end of the lower piece portion 5f extends from a second end of the upper piece portion 5d, and an inner vertical piece portion 5g having a linear shape extends from a second end of the lower piece portion 5f.

The square wave-shaped spring portion 5k in which a plurality of linear spring pieces are connected by corner portions 5m as described above has a characteristic that, as described below, the stress generated when the spring portion 5k is displaced in the Y direction and the Z direction is less likely to be dispersed over the entire spring portion 5k than the round wave-shaped spring portion of the conventional art having a curved bent portion.

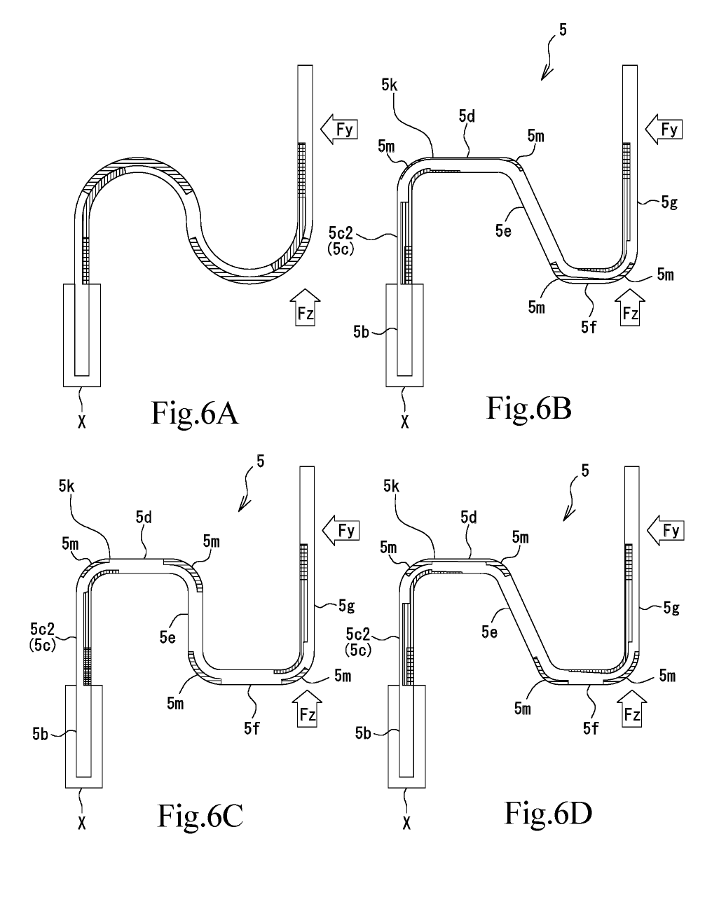

FIG. 6A is a schematic diagram of the stress distribution generated in the round wave-shaped spring portion of the conventional art, and FIG. 6B is a schematic diagram of the stress distribution generated in the square wave-shaped spring portion 5k of this embodiment. In FIGS. 6A to 6D, each terminal is fixed at the fixing portion X, the simulation result of the stress distribution when the load Fy in the Y direction acts is schematically shown by horizontal hatching, and the simulation result of the stress distribution when the load Fz in the Z direction acts is schematically shown by vertical hatching.

In the conventional round wave-shaped spring portion, when a load Fy is applied, stress is generated over the entire length of the two curved portions, and stress is generated deeply also in the plate thickness direction, and stress is generated throughout the round wave-shaped spring portion. In contrast, in the square wave-shaped spring portion 5k according to this embodiment, when a load Fy is applied, stress is distributed in the surface layer portions of the upper piece portion 5d, the lower piece portion 5f, and the corner portions 5m, and in the plate thickness direction, the stress is not distributed more deeply than in the spring portion of the conventional art. Similarly, when the load Fz acts upward in the Z direction, in the round wave-shaped spring portion, stress is generated deeply in the plate thickness direction whereas in the square wave-shape spring portion 5k, stress is generated in the surface layer portions of the corner portions 5m. Therefore, in the spring portion 5k of this embodiment, the displacement load can be reduced, and when the same load is applied, the amount of displacement can be increased.

In addition, although the central vertical piece 5e is formed obliquely, as compared with a modification in which the central vertical piece extends in the vertical direction as shown in FIG. 6C, since the central vertical piece 5e extends obliquely, the spring length is long, so it can be seen that displacement load can be reduced.

Since, in the movable connector 1, the displacement load of the spring portion 5k can be reduced, both the contact pressure by the contact portion 5j and the displacement load of the spring portion 5k can be reduced. Therefore, it is possible to realize a Z-direction movable connector that has good workability of inserting and extracting a connection object and has high reliability of conductive connection.

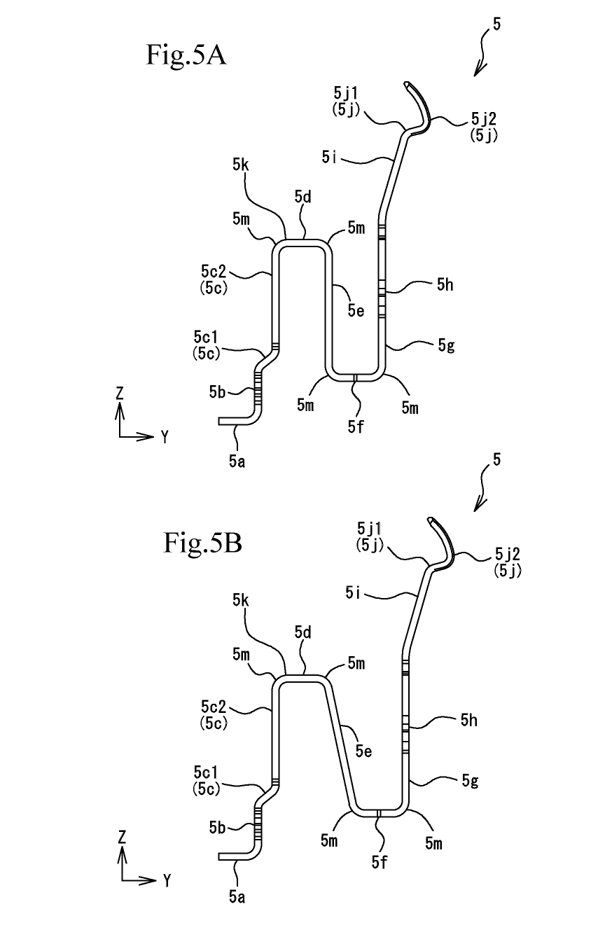

The upper piece portion 5d of the spring portion 5k is formed to be longer than the lower piece portion 5f. When the upper piece portion 5d on the fixed housing 3 side is lengthened, the displacement load of the whole spring portion 5k can be further reduced. That is, FIG. 6D is a schematic diagram of a simulation result of a stress distribution corresponding to a modification of FIG. 5B to be described later. When comparing the upper piece portions 5d to each other, the upper piece portion 5d of this embodiment is more flexible because the spring length is long, and the stress generated in the plate thickness direction is small. Therefore, by forming the upper piece portion 5d longer than the lower piece portion 5f, it is possible to further reduce the displacement load of the spring portion 5k.

### Modifications of Embodiment (FIGS. 5A and 5B)

Since the above embodiment can be implemented in modifications, an example thereof will be described.

The shape of the spring portion 5k shown in the above embodiment is an example, and other shapes shown in FIGS. 5A and 5B, for example, can be used. In FIG. 5A, the central vertical piece 5e is formed to extend in the vertical direction, and the upper piece portion 5d and the lower piece portion 5f have the same length. In FIG. 5B, the upper piece portion 5d and the lower piece portion 5f have the same length. Even with these spring portions 5k, the displacement load can be made smaller than that of the spring portion of the conventional art.

In the above embodiment, the outer vertical piece portion 5c has the bent portion 5c1, but the outer vertical piece portion 5c may have only the straight portion 5c2.

In the above embodiment, the spring portion 5k has the inner vertical piece portion 5g. However, the spring portion 5k may not have the inner vertical piece portion 5g, and the terminal 5 may have such a shape that the end of the lower piece portion 5f is directly connected to the movable housing fixing portion 5h.

What is claimed is:

1. A movable connector comprising:
a first housing;
a second housing that is fitted and connected to a connection object; and
a terminal including a first fixing portion fixed to the first housing, a second fixing portion fixed to the second housing, a spring portion connecting the first fixing portion and the second fixing portion and supporting the second housing displaceably relative to the first housing, and a contact portion that makes conductive contact with the connection object,
wherein the spring portion has an upper piece portion and a lower piece portion having a linear shape and extending in a direction intersecting with a fitting direction in which the connection object is fitted and connected to the second housing, a first extending portion connecting a first end of the upper piece portion and the first fixing portion, and a second extending portion connecting a second end of the upper piece portion and a first end of the lower piece portion.

2. The movable connector according to claim 1, wherein the second extending portion has such a shape that it extends obliquely so as to be gradually separated from the first extending portion from the second end of the upper piece portion toward the first end of the lower piece portion.

3. The movable connector according to claim 1, wherein the upper piece portion is formed to be longer than the lower piece portion.
